(19) United States
(12) Patent Application Publication
(10) Pub. No.: US 2026/0175509 A1
(43) Pub. Date: Jun. 25, 2026

(54) INJECTION-BLOW-MOULDING MOULD AND METHOD

(71) Applicant: Molmasa Aplicaciones Tecnicas, SL, Montcada i Reixac (ES)

(72) Inventors: Angel Atance Orden, Barcelona (ES); David Carrillo Guerrero, Cerdanyola del Valles (ES)

(21) Appl. No.: 19/542,139

(22) Filed: Feb. 17, 2026

Related U.S. Application Data
(63) Continuation-in-part of application No. 18/261,171, now Pat. No. 12,583,168.

(30) Foreign Application Priority Data
Jan. 13, 2021 (EP) 21382013.7

(51) Int. Cl. B29C 49/58; B29C 49/06; B29C 49/64; B29L 31/00

(52) U.S. Cl. CPC B29C 49/58; B29C 49/06; B29C 49/6604; B29C 2049/5841; B29C 2049/6606; B29L 2031/712

(57) ABSTRACT

The injection-blow-moulding mould includes a non-expandable punch having a first opening connected to a first conduit which is in communication with a first source of pressurised gas supply configured to supply pressurised gas through the first opening at an overpressure above a blowing pressure suitable to blow a preform into a container and an second opening connected to a second conduit which is in communication with a pressure-limiting device set at the blowing pressure. A blow-moulding cavity is configured to receive therein the non-expandable punch with a hot and soft preform arranged thereon, and a cooling device associated to the blow-moulding cavity. Gas inside the container exceeding the blowing pressure is allowed to escape through the second opening thereby a cooling gas stream is created from the first opening to the second opening.

### RELATED APPLICATIONS

This application is a continuation-in-part of U.S. patent application Ser. No. 18/261,171 filed Jul. 12, 2023, which claims priority to International Application No. PCT/EP2022/050515, filed Jan. 12, 2022, the contents of which are herein incorporated by reference in their entirety.

### FIELD OF THE INVENTION

The present invention generally relates to an injection-blow-moulding mould and method and more in particular to a mould and a method for injection-moulding plastic preforms and blow-moulding the preforms into containers. The injection-blow-moulding mould and the method are useful for a container-forming machine.

### BACKGROUND

A type of container-forming machines comprising a preform-forming unit configured to form preforms by injection of molten plastic material in a preform mould and a container-forming unit configured to form containers by blowing the preforms in a blow-moulding mould are known.

In this known type of container-forming machines, the preform mould comprises a preform-moulding cavity which has an inner surface defining an outer surface of the preform in cooperation with a non-expandable punch which has an outer surface defining an inner surface of the preform, and the injection-blow-moulding mould comprises a blow-moulding cavity which has an inner surface defining an outer surface of the containers to be obtained by blowing the preforms, the blow-moulding cavity being configured to receive therein the non-expandable punch with one of the preforms arranged on the non-expandable punch in a hot and soft state.

The injection-blow-moulding mould comprises a blowing device configured to deliver a pressurised gas to the interior of the heated and soft preform through one or more first openings located in the non-expandable punch when the non-expandable punch carrying the preform is located inside the blow-moulding cavity in order to expand the preform until the expanded preform is applied to the inner surface of the blow-moulding cavity to form the container, and a cooling device associated to the blow-moulding cavity and configured to cool the outer surface of the container which is in contact with the inner surface of the blow-moulding cavity.

Different types of transfer devices for transferring the non-expandable punch carrying thereon the heated and soft preform from the preform-moulding cavity to the blow-moulding cavity are known.

Document WO 2017093578 A1 discloses an injection and blow mould comprising one or more rows of moulding cavities arranged on a base plate, each row of cavities including an integer number n greater than one of injection-moulding cavities and a number n+1 of blow-moulding cavities alternating with each other and mutually aligned, with blow-moulding cavities on opposite ends of the row, and one or more rows of non-expandable punches arranged on a mobile plate, each row of non-expandable punches including a number 2n of mutually aligned non-expandable punches. The mobile plate is actuated to perform alternating movements to transfer the non-expandable punches from the injection-moulding cavities to the blow-moulding cavities and vice versa.

The mould of cited document WO 2017093578 A1 further includes a plurality of injection nozzles configured to inject a molten plastic material to the injection-moulding cavities in order to mould preforms on the non-expandable punches which are in the injection-moulding cavities and a blowing device configured to supply compressed gas through first openings located in the non-expandable punches to the interior of the preforms arranged on the non-expandable punches which are in the blow-moulding cavities in order to expand the preforms into containers. The injection-moulding cavities and the blow-moulding cavities are formed in respective individual injection blocks and individual blow blocks separate from each other. The blow blocks are cooled by a cooling fluid circulating via cooling conduits arranged inside the blow blocks in order to cool an outer surface of the containers in contact with an inner surface of the blow-moulding cavities.

In any case, the containers once formed have to reach a lower temperature than a temperature of the blow-moulding mould for acquiring enough consistency to enable being extracted from the injection-blow-moulding mould without deforming, and this temperature lowering takes a time that slows the production rate of the container-forming machine.

When injection-blow-moulding moulds having a cooling device comprising, for example, a cooling fluid circulating via cooling conduits in the blow-moulding cavities are used, the cooling device cools only the outer surface of the container which is in contact with the inner surface of the blow-moulding cavity but does not cool the inner surface of the container, thereby a relatively long cooling time is still required before the container can be extracted from the injection-blow-moulding mould without deforming.

DE2605967A1 refers to a blow moulding that is internally cooled by circulating mist-supplied and extracted through internal ducts in blowing mandrel disclosing an injection-blow-moulding mould comprising in combination the features included in the preamble of claim 1 of this patent application.

U.S. Pat. No. 3,944,141 also discloses such a mould although it uses in addition a pressure bag.

However, there is a need for an injection-blow-moulding mould provided with means for cooling both the outer and inner surfaces of the container once expanded in the blow-moulding cavity in order to reduce the necessary cooling time before the finished container can be extracted from the injection-blow-moulding mould.

### SUMMARY OF THE INVENTION

According to a first aspect, the present invention contributes to fulfilling the above need by providing an injection-blow-moulding mould comprising a non-expandable punch having an outer surface which defines an inner surface of preforms made of plastic, an injection-moulding cavity having an inner surface defining an outer surface of the preforms is configured to receive therein the non-expandable punch, and a blow-moulding cavity having an inner surface defining an outer surface of containers to be obtained by blowing the preforms.

The injection-moulding cavity is configured to receive therein the non-expandable punch, and an injection device is configured to inject a molten plastic material in the injection-moulding cavity through one or more injection nozzles when the non-expandable punch is located inside the injection-moulding cavity, whereby the preforms are formed.

The blow-moulding cavity is configured to receive therein the non-expandable punch with one of the preforms arranged on the non-expandable punch in a hot and soft state.

A transfer device can be optionally provided for transferring the non-expandable punch from the injection-moulding cavity to the blow-moulding cavity, and vice versa.

A blowing device configured to deliver a pressurised gas to the interior of the preform simultaneously through the at least one first opening and through the at least one second opening during a blowing phase to inflate the preform into the blow-moulding cavity until completely fills the blow-moulding cavity, the preform becoming the container. Whereby the preform is expanded and blow-moulded to adopt the shape of the container defined by the inner surface of the blow-moulding cavity.

The blowing device is also configured to deliver the pressurized gas to the interior of the preform only through either the at least one first opening or to the at least one second opening during a cooling phase following the blowing phase.

A pressure-limiting device, connected to the at least one first opening or the at least one second opening which does not deliver pressurized gas of the blowing device during the cooling phase, and configured to release the pressurized gas from an interior of the container during the cooling phase creating a cooling stream of pressurised gas, between the opposite ends of the non-expandable punch, in direct contact with an inner surface of the container.

Preferably, the blowing device is configured to deliver the pressurised gas at different pressures through the at least one first opening and through the at least one second opening.

The blowing device can be also configured to deliver the pressurised gas into the preform during the blowing phase at a blowing pressure, suitable to blow the preform into the container, through the at least one first or second opening connected to the pressure-limiting device, and configured to deliver the pressurized gas into the preform during the blowing phase at an overpressure above the blowing pressure, through the at least one first or second opening not connected to the pressure-limiting device.

This difference in the pressure ensures that a gas stream is created from the first or second openings with a higher pressure (overpressure above the blowing pressure) to the first or second openings with a lower pressure (blowing pressure), during the cooling phase.

Thus, when the preform is completely expanded into the container, the gas inside the container accumulates exceeding the blowing pressure, then the pressure-limiting device releases pressurised gas from the interior of the container, creating a gas stream from first or second openings with a higher pressure to the first or second openings connected to the pressure-limiting device.

This contributes to shorten the cooling time necessary for the finished container can be extracted from the blow-moulding cavity without deforming, thereby enhancing the production rate.

In order to cool an outer surface of the formed container which is in contact with the inner surface of the blow-moulding cavity, the injection-blow-moulding mould can be provided with a cooling device configured to cool the inner surface of the blow-moulding cavity.

Thus, when the preform is completely expanded into the container, the gas inside the container exceeds the blowing pressure and a gas stream is created from the one or more first openings to the one or more second openings that cools an inner surface of the container, which adds to the cooling of the outer surface of the container performed by the cooling device and contributes to shorten the cooling time necessary for the finished container can be extracted from the blow-moulding cavity without deforming, thereby enhancing the production rate.

When using the injection-blow moulding mould of the present invention, the improvement achieved by cooling the wall of the container at the same time by the inside and by the outside contributes to create a solid skin at both sides of the plastic wall of the container, thus providing a stable structure for the container that prevents subsequent deformations.

Optionally, the blowing device includes a first blowing device including a first source of pressurized gas configured to provide pressurized gas at the overpressure above the blowing pressure, and a second blowing device including a second source of pressurized gas configured to provide pressurized gas at the blowing pressure.

The pressure-limiting device can be connected to the at least one second opening located at a proximal end of the non-expandable punch, creating a cooling gas stream into the container from a distal end of the non-expandable punch towards a proximal end thereof.

Alternatively, the pressure-limiting device can be connected to the at least one first opening located at a distal end of the non-expandable punch, creating a cooling gas stream into the container from a proximal end of the non-expandable punch towards a distal end thereof.

The pressure-limiting device can comprise, for example, a pressure-limiting valve set to open when the pressure in the interior of the container is above the blowing pressure, releasing pressurized gas from the interior of the container.

All the above features that will be illustrated in FIGS. 1 to 3B of the drawings pertain to the prior art as disclosed for example in the referred DE2605967A.

The injection-blow-moulding mould further comprises an opening and closing device configured to open and close the one or more first openings and the one or more second openings when the non-expandable punch carrying the preform is located inside the blow-moulding cavity.

To that end, the non-expandable punch comprises a base body and a forming body. The forming body is movable with respect to the base body in an axial direction coaxial to a longitudinal axis of the non-expandable punch between an open position and a closed position. In the open position a gap between the base body and the forming body is formed which provides a proximal gas passage. In the closed position there is no gap or gas passage between the base body and the forming body.

The non-expandable punch further comprises a valve body which is movable with respect to the forming body in the axial direction between an open position and a closed position. In the open position a gap between the forming body and the valve body is formed which provides a distal gas passage. In the closed position there is no gap or gas passage between the forming body and the valve body.

In a first example, the proximal gas passage is connected to the second conduit so that the proximal gas passage constitutes the one or more second openings, and the distal gas passage is connected to the first conduit so that the distal gas passage constitutes the one or more first openings. An actuator is operatively connected to move the forming body between the open position and the closed position in order to open and close the one or more second openings, and an elastic element is arranged to bias the valve body to the closed position, with the elastic element being set to allow the valve body to be moved to the open position by the effect of the overpressure in the first conduit, in order to open and close the one or more first openings.

In this first example, the one or more first openings, which are provided by the distal gas passage, are preferably formed as a single aperture all around the longitudinal axis of the non-expandable punch, and are optionally located at a distal area of the non-expandable punch defining a region of the preform intended to form a bottom of the container, and the one or more second openings, which are provided by the proximal gas passage, are preferably formed as a single opening all around the longitudinal axis of the non-expandable punch, and are optionally located at a proximal area of the non-expandable punch defining a region of the preform intended to form a shoulder of the container.

In a second example, the proximal gas passage is connected to the first conduit so that the proximal gas passage constitutes the one or more first openings, and the distal gas passage is connected to the second conduit so that the distal gas passage constitutes the one or more second openings. A first actuator is operatively connected to move the forming body between the open position and the closed position in order to open and close the one or more first openings, and a second actuator is operatively connected to move the valve body between the open position and the closed position in order to open and close the one or more second openings.

In this second embodiment, the one or more first openings, which are provided by the proximal gas passage, are preferably formed as a single opening all around the longitudinal axis of the non-expandable punch, and are optionally located at a proximal area of the non-expandable punch defining a region of the preform intended to form a shoulder of the container, and the one or more second openings, which are provided by the distal gas passage, are preferably formed as a single opening all around the longitudinal axis of the non-expandable punch, and are optionally located at a distal area of the non-expandable punch defining a region of the preform intended to form a bottom of the container.

Throughout this specification, the term “proximal” is used to designate a site near the base body of the non-expandable punch and the term “distal” is used to designate a site away from the base body of the non-expandable punch.

Any one of the first, second and third variants of the blowing device can be combined with any one of the first and second embodiments of the injection-blow moulding mould without departing from the scope of the present invention.

According to a second aspect, the present invention provides an injection-blow-moulding method comprising the following conventional steps:
receiving a non-expandable punch inside a blow-moulding cavity with a preform arranged on the non-expandable punch in a hot and soft state, the non-expandable punch being non-expandable, being elongated in the axial direction and including at least one first opening and at least one second opening separated in the axial direction at opposite ends thereof, and the blow-moulding cavity defining an outer surface of a container to be obtained by blowing the preform;
delivering a pressurised gas to an interior of the preform simultaneously through at least one first opening and through at least one second opening during a blowing phase inflating the preform into the blow-moulding cavity until completely fills the blow-moulding cavity, the preform becoming the container;
delivering pressurised gas to the interior of the container only through either the at least one first opening or the at least one second opening during a cooling phase following the blowing phase, while releasing the pressurized gas from the interior of the container through either the at least one first opening or the at least one second opening not delivering pressurised gas to the interior of the container, creating a cooling stream of pressurised gas between the opposite ends of the non-expandable punch in direct contact with an inner surface of the container.

In addition, the pressurised gas can be delivered at different pressures through the at least one first opening and through the at least one second opening.

For example, the pressurised gas can be delivered into the preform during the blowing phase at a blowing pressure, suitable to blow the preform into the container, through the at least one first or second opening connected to the pressure-limiting device, and the pressurized gas can be delivered into the preform during the blowing phase at an overpressure above the blowing pressure, through the at least one first or second opening not connected to the pressure-limiting device.

The pressurised gas can be released from the interior of the container through the at least one second opening, which is located at a proximal end of the non-expandable punch, creating a cooling gas stream into the container from a distal end of the non-expandable punch towards a proximal end thereof.

Alternatively, the pressurised gas can be released from the interior of the container through the at least one first opening located, which is located at a distal end of the non-expandable punch, creating a cooling gas stream into the container from a proximal end of the non-expandable punch towards a distal end thereof.

It will be understood that the non-expandable punch extends in cantilever from a base, with the distal end being the end furthest away from said base and the proximal end being the end closest to said base.

The release of the pressurised gas during the cooling phase can be produced by opening a pressure-limiting valve set to open when the pressure in the interior of the container is above the blowing pressure.

### BRIEF DESCRIPTION OF THE DRAWINGS

The foregoing features and advantages will be more fully understood from the following detailed description of several illustrative and not limitative embodiments with reference to the accompanying drawings, in which:

FIG. 1 is a cross sectional view of a non-expandable punch, an injection-moulding cavity and a blow-moulding cavity belonging to an injection-blow-moulding mould according to the cited prior art (see DE2605967A), in an open position;

FIG. 2 is a cross sectional view of the non-expandable punch and the blow-moulding cavity of FIG. 1, in a closed position;

FIGS. 3A and 3B are diagrammatic views of the non-expandable punch and the blow-moulding cavity of FIGS. 1 and 2 in cooperation with a first variant of a blowing device in two different operating stages;

FIGS. 4A and 4B are diagrammatic views of the non-expandable punch and the blow-moulding cavity of FIGS. 1 and 2 in cooperation with the blowing device in two different operating stages in accordance with the principles of the present invention.

FIGS. 5A and 5B are diagrammatic views of the non-expandable punch and the blow-moulding cavity of FIGS. 1 and 2 in cooperation with a third variant of the blowing device as per one additional embodiment forming part of this invention in two different operating stages; and

FIG. 6 is a cross sectional view of a non-expandable punch and a blow-moulding cavity belonging to an injection-blow-moulding mould according to a second example in a closed position.

### DETAILED DESCRIPTION

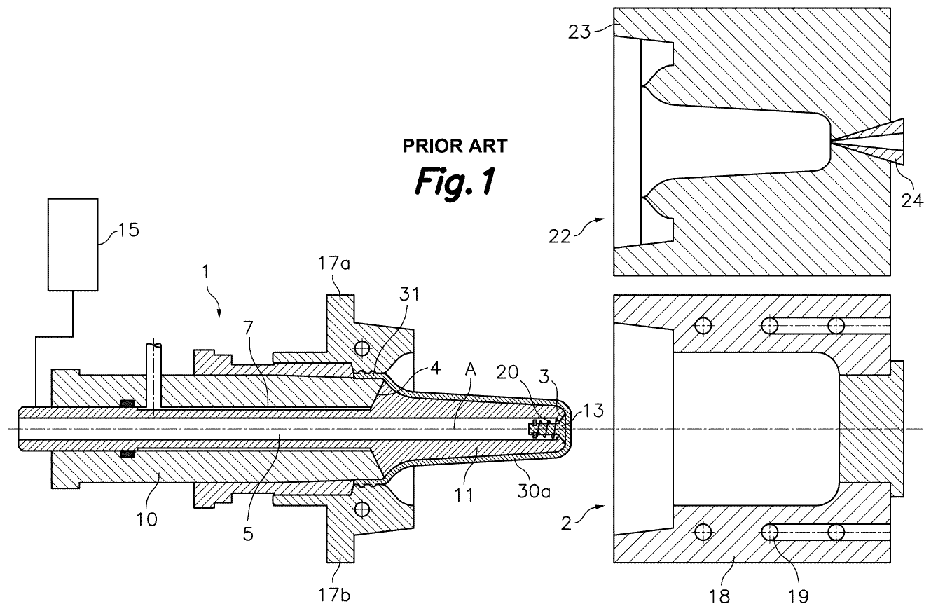

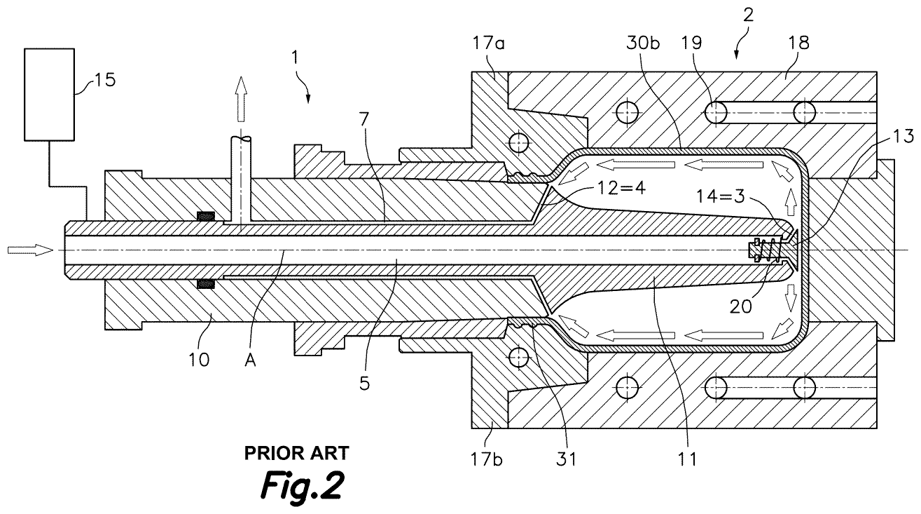

Referring first to FIGS. 1 and 2, reference signs 1, 22 and 2 designate a non-expandable punch, an injection-moulding cavity and a blow-moulding cavity, respectively, of an injection-blow-moulding mould according to a first embodiment of the present invention.

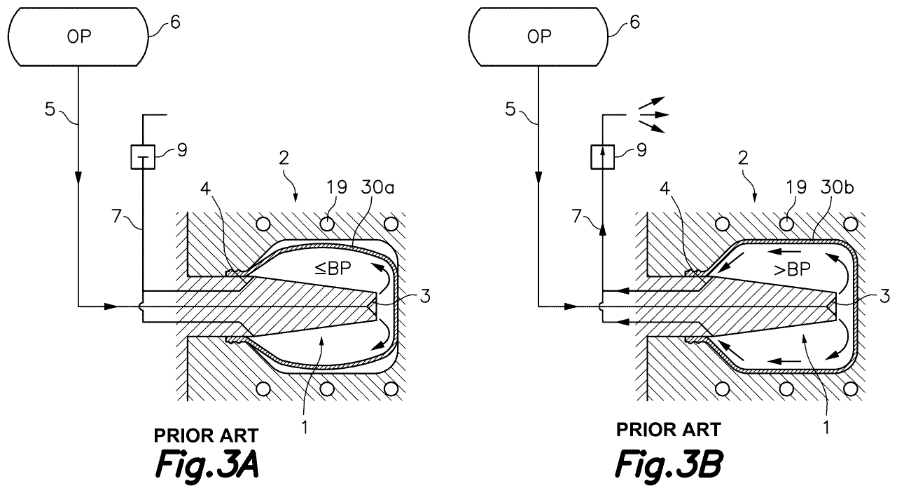

In FIGS. 1 and 2 some elements belonging to a blowing device have been omitted since they will be explained in detail below with reference to FIGS. 3A, 3B; 4A, 4B; and 5A, 5B.

The non-expandable punch 1 has a longitudinal axis A and the injection-moulding cavity 22 and the blow-moulding cavity 2 have respective longitudinal axes, for example parallel to the longitudinal axis A of the non-expandable punch 1.

A transfer device (not shown) can be configured for transferring the non-expandable punch from the inside of the injection-moulding cavity to the inside of the blow-moulding cavity, and vice versa.

The non-expandable punch 1 has an outer surface defining an inner surface of a preform 30a and the injection-moulding cavity 22, which is formed in an injection-moulding block 23, defines an outer surface of the preforms 30a. The injection-moulding cavity 22 is configured to receive therein the non-expandable punch 1 in a closed position (not shown) and the injection-moulding block 23 has an injection nozzle 24 through which an injection device is allowed to inject a molten plastic material to the injection-moulding cavity 22 to form the preform 30a by injection moulding, as is conventional in the prior art.

The non-expandable punch 1 and the blow-moulding cavity 2, when are mutually aligned as shown in FIGS. 1 and 2, are movable between an open position (FIG. 1), in which the non-expandable punch 1 and the blow-moulding cavity 2 are separated from each other, and a closed position (FIG. 2), in which the non-expandable punch 1 is coupled to the blow-moulding cavity 2 forming together the injection-blow-moulding mould.

The blow-moulding cavity 2 has an inner surface defining an outer surface of a container 30b to be obtained by blowing or blow-moulding mould the preform 30a. The non-expandable punch 1 carries arranged thereon one of the preforms 30a in a hot and soft state when the non-expandable punch 1 is received in the blow-moulding cavity 2 to form a blow-moulding mould. In the illustrated example, the preform 30a has a neck portion 31 formed in cooperation with two neck half-moulds 17a, 17b which move together with the non-expandable punch 1 and which are also coupled to the blow-moulding cavity 2 in the mould closed position.

The non-expandable punch 1 can be comprised of a base body 10, a forming body 11, and a valve body 13.

The forming body 11 will be movable with respect to the base body 10 in an axial direction coaxial to the longitudinal axis A of the non-expandable punch 1 between a closed position (FIG. 1), in which there is no gap between the base body 10 and the forming body 11, and an open position (FIG. 2), in which a gap providing a proximal gas passage 12 is formed between the base body 10 and the forming body 11.

The valve body 13 will be movable with respect to the forming body 11 in the axial direction between a closed position (FIG. 1), in which there is no gap between the forming body 11 and the valve body 13, and an open position (FIG. 2), in which a gap providing a distal gas passage 14 is formed between the forming body 11 and the valve body 13.

In this example, the proximal gas passage 12 is formed all around the longitudinal axis A of the non-expandable punch 1 and is located at a proximal area of the non-expandable punch 1 defining a region of the preform 30a intended to form a shoulder of the container 30b, and the distal gas passage 14 is formed all around the longitudinal axis A of the non-expandable punch 1 and is located at a distal area of the non-expandable punch 1 defining a region of the preform 30a intended to form a bottom of the container 30b. In the first embodiment shown in FIGS. 1 and 2, the distal gas passage 14 constitutes a first opening 3 which is connected to a first conduit 5 and the proximal gas passage 12 constitutes a second opening 4 connected to a second conduit 7.

In this first embodiment as per the state of the art, an actuator 15 (symbolically depicted in FIGS. 1 and 2) is operatively connected to move the forming body 11 between the open position and the closed position, and an elastic element 20 is arranged to bias the valve body 13 to the closed position. The elastic element 20 is, for example, a helical spring set to allow the valve body 13 to be moved to the open position by the effect of a particular pressure in the first conduit 5.

The proposed blow-moulding mould further includes a blowing device configured to deliver a pressurised gas to the interior of the preform simultaneously through the at least one first opening and through the at least one second opening during a blowing phase to inflate the preform into the blow-moulding cavity until completely fills the blow-moulding cavity, the preform becoming the container.

The blowing device is also configured to deliver the pressurized gas to the interior of the preform only through either the at least one first opening or to the at least one second opening during a cooling phase following the blowing phase.

The blow-moulding mould also includes a pressure-limiting device, connected to the at least one first opening or the at least one second opening which does not deliver pressurized gas of the blowing device during the cooling phase. Said pressure-limiting device is configured to release the pressurized gas from the interior of the container during the cooling phase creating a cooling stream of pressurised gas, between the opposite ends of the non-expandable punch. This cooling stream of pressurised gas will be in direct contact with an inner surface of the container.

For example, the blowing device can be adapted to deliver a pressurised gas to the interior of the hot and soft preform 30a through the first opening 3 and through the second opening 4 to expand the preform 30a against the inner surface of the blow-moulding cavity 2 in order to form one of the containers 21 during the blowing phase.

Once the blowing of the preform into the container has been completed the preform cannot expand and the pressure of the pressurised gas in the interior of the formed container increases above the blowing pressure, moment in which the blowing phase ends and the cooling phase starts.

In that moment, the pressure-limiting device opens, releasing the pressurised gas from the interior of the container through for example the second openings 4, while the blowing device continues delivering pressurized gas through the first openings 3, or vice-versa.

Thereby, as indicated by the thick arrows in FIG. 2, once the container 30b is formed and before it is extracted from the blow-moulding mould, a gas stream is created inside the container 30b, from the first opening 3 adjacent the bottom of the container 30b to the second opening 4 adjacent the shoulder of the container 30b, that cools an inner surface of the container 30b, or vice-versa.

For this reason, the first opening 3 and the second opening 4 are located in the non-expandable punch 1 at respective positions the most spaced apart possible from each other.

The blow-moulding cavity 2 is formed in blow-moulding blocks 18 inside which cooling conduits 19 are arranged, and a cooling device is configured for circulating a cooling fluid via the cooling conduits 19 in order to cool the inner surface of the blow-moulding cavity 2 and the outer surface of the container 30b in contact therewith. Thus, both the inner and outer surfaces of the container 30b are cooled before the container 30b is extracted from the blow-moulding mould, which shortens the cycle time and increases the production rate.

First (according to the state of the art), second and third variants of the blowing device and the operation thereof are explained now with reference to FIGS. 3A, 3B, FIGS. 4A, 4B, and FIGS. 5A, 5B, respectively, in cooperation with the elements of the first embodiment.

All the first, second and third variants of the blowing device have in common that the first conduit 5 to which the first opening 3 is connected is in communication with a first source of pressurised gas supply 6 configured to supply pressurised gas through the first opening 3 at an overpressure OP, for example 12 bar, above a blowing pressure BP, for example 9 bar, wherein the blowing pressure BP is a pressure suitable to completely expand the preform 30a until it is applied against the inner surface of the blow-moulding cavity 2 and acquires the shape of the container 30b.

However, in the first, second and third variants of the blowing device, the second conduit 7 to which the second opening 4 is connected is in communication with a pressure-limiting device set at the blowing pressure BP. The pressure-limiting device, which is different for each variant, is configured to allow the gas inside the container 30b, when it exceeds the blowing pressure BP, to escape through the second opening 4.

In the first variant of the blowing device shown in FIGS. 3A and 3B, the pressure-limiting device which is in communication with the second conduit 7 connected to the second opening 4 simply comprises a pressure-limiting valve 9 (see FIGS. 3A and 3B) set at the blowing pressure BP.

As shown in FIG. 3A, when performing a blowing operation with the second variant of the blowing device, firstly pressurized gas from the first source of pressurised gas supply 6, at the overpressure OP, is supplied through the first opening 3 to the interior of the preform 30a, thereby the preform 30a begins to expand and the pressure inside it raises from a pressure below the blowing pressure BP towards the blowing pressure BP while the pressure-limiting valve 9 remains closed.

Then, as shown in FIG. 3B, when the preform 30a has been completely expanded against the inner surface of the blow-moulding cavity 2 to form the container 30b, the first source of pressurised gas supply 6 continues supplying pressurized gas at the overpressure OP through the first opening 3 and the pressure inside the container 30b raises to a level that exceeds the blowing pressure BP, which causes the pressure-limiting valve 9 to open, thereby allowing the gas inside the container 30b to escape through the second opening 4 thus creating a cooling gas stream inside the container 30b from the first opening 3 to the second opening 4.

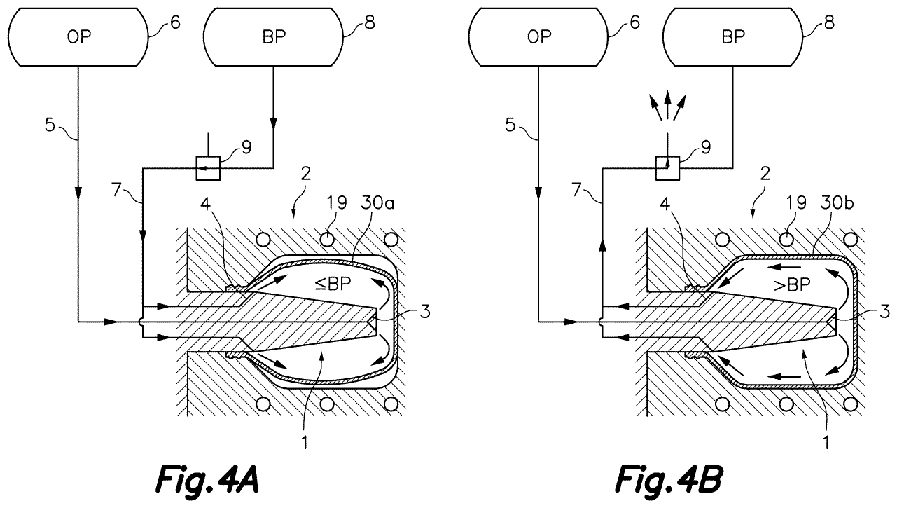

In a second variant of the blowing device as per a first embodiment of this invention shown FIGS. 4A and 4B, the pressure-limiting device which is in communication with the second conduit 7 connected to the second opening 4 comprises a second pressurised gas supply source 8 in communication with the second conduit 7 and a pressure-limiting valve 9 located in the second conduit 7 between the second opening 4 and the second pressurised gas supply source 8. The second pressurised gas supply source 8 is configured to supply pressurised gas through the second opening 4 at the blowing pressure BP. The pressure-limiting valve 9 is configured to allow the pressurized gas at the blowing pressure BP to flow from the second pressurised gas supply source 8 to the interior of the preform 30a through the second opening 4 when the pressure in the interior of the preform 30a is below or at the blowing pressure BP and to allow the pressurized gas to escape from the interior of the container 30b through the second opening 4 when the pressure in the interior of the container 30b is above the blowing pressure BP.

As shown in FIG. 4A, when performing a blowing operation with the second variant of the blowing device in accordance with the principles of this invention, firstly pressurized gas from the first source of pressurised gas supply 6, at the overpressure OP, is supplied through the first opening 3 to the interior of the preform 30a and at the same time pressurized gas from the second source of pressurised gas supply 8, at the blowing pressure BP, is supplied through the pressure-limiting valve 9 and the second opening 4 to the interior of the preform 30a, thereby the preform 30a begins to expand and the pressure inside it raises from a pressure below the blowing pressure BP towards the blowing pressure BP.

Then, as shown in FIG. 4B, when the preform 30a has been completely expanded against the inner surface of the blow-moulding cavity 2 to form the container 30b, the first source of pressurised gas supply 6 continues supplying pressurized gas at the overpressure OP through the first opening 3, which makes the pressure inside the container 30b to exceed the blowing pressure BP thereby causing the gas inside the container 30b to escape through the second opening 4 and the pressure-limiting valve 9 to shift closing the gas passage back to the second source of pressurised gas supply 8 and allowing the gas to escape from the pressure-limiting valve 9, thus creating a cooling gas stream inside the container 30b from the first opening 3 to the second opening 4.

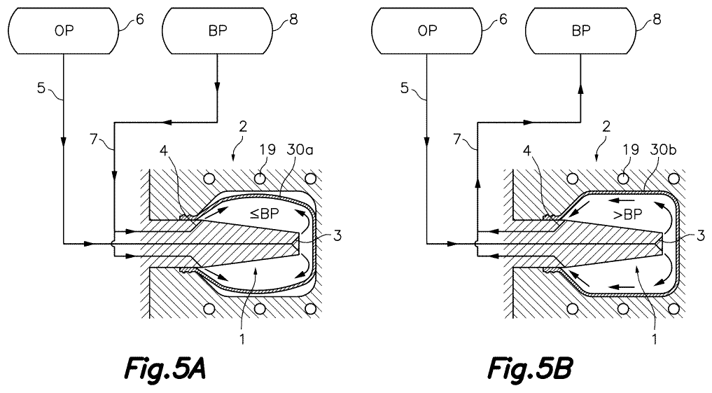

In the third variant of the blowing device as per this invention that is shown n FIGS. 5A and 5B, the pressure-limiting device which is in communication with the second conduit 7 connected to the second opening 4 comprises a second pressurised gas supply source 8 configured to supply pressurised gas through the second opening 4 at the blowing pressure BP and to retrieve pressurized gas flowing out the container 30b through the second opening 4 when the pressure in the interior of the container 30b is above the blowing pressure BP.

As shown in FIG. 5A, when performing a blowing operation with the third variant of the blowing device, firstly pressurized gas from the first source of pressurised gas supply 6, at the overpressure OP, is supplied through the first opening 3 to the interior of the preform 30a and at the same time pressurized gas from the second source of pressurised gas supply 8, at the blowing pressure OP, is supplied through the second opening 4 to the interior of the preform 30a, thereby the preform 30a begins to expand and the pressure inside it raises from a pressure below the blowing pressure BP towards the blowing pressure BP.

Then, as shown in FIG. 5B, when the preform 30a has been completely expanded against the inner surface of the blow-moulding cavity 2 to form the container 30b, the first source of pressurised gas supply 6 continues supplying pressurized gas at the overpressure OP through the first opening 3, which makes the pressure inside the container 30b to exceed the blowing pressure BP and allows the gas inside the container 30b to escape through the second opening 4 to return to the second source of pressurised gas supply 8 creating a cooling gas stream inside the container 30b from the first opening 3 to the second opening 4.

The blowing device according to any one of the first, second or third variants can comprise other valve elements and/or accessories (not shown) which are of common use in pneumatic circuits, and which would not alter the operation of the blowing device as explained above.

When using the blowing device according to the first variant shown in FIGS. 3A and 3B or to the second variant shown in FIGS. 4A and 4B, the compressed gas output generated by the pressure in excess to the blow pressure BP through the second opening 4 and the pressure-limiting valve 9 may be advantageously directed to a suitably dimensioned tank (not shown) or to a network pressurized gas line (not shown), so that this pressurized gas, which is near to the blow pressure BP, can be used for any other purpose, such as driving pneumatic pistons or other accessory elements of the same injection-blow-moulding mould or other machine or equipment.

Thus, an increased consumption of pressurized gas due to the cooling gas stream created inside the container 30b is mitigated by being able to use the exhausted pressurized gas for driving other pneumatic mechanisms.

The use of a second source of pressurised gas supply 8 in addition to the first source of pressurised gas supply 6, as with the blowing device according to the second variant shown in FIGS. 4A and 4B or to the third variant shown in FIGS. 5A and 5B, implementing the principles of this invention allows the blow pressure BP to be reached more quickly inside the container 30b thereby contributing to additionally reduce the cycle time and to increase the productivity of the system.

When using the blowing device according to the third variant shown in FIGS. 5A and 5B, it has to be taken into account that the pressurized gas coming out from the second opening 4 which is returned to the second source of pressurised gas supply 8 is relatively hot after having been cooling the inner surface of the container 30b and preferably must be cooled back before being supplied again to the interior of a container 30b in a subsequent blowing cycle.

When any one of the second or third variants of the blowing device is applied to the first embodiment shown in FIGS. 1 and 2, the elastic element 20 is set to allow the valve body 13 to be moved to the open position by the effect of the overpressure OP in the first conduit 5 provided by the first source of pressurised gas supply 6.

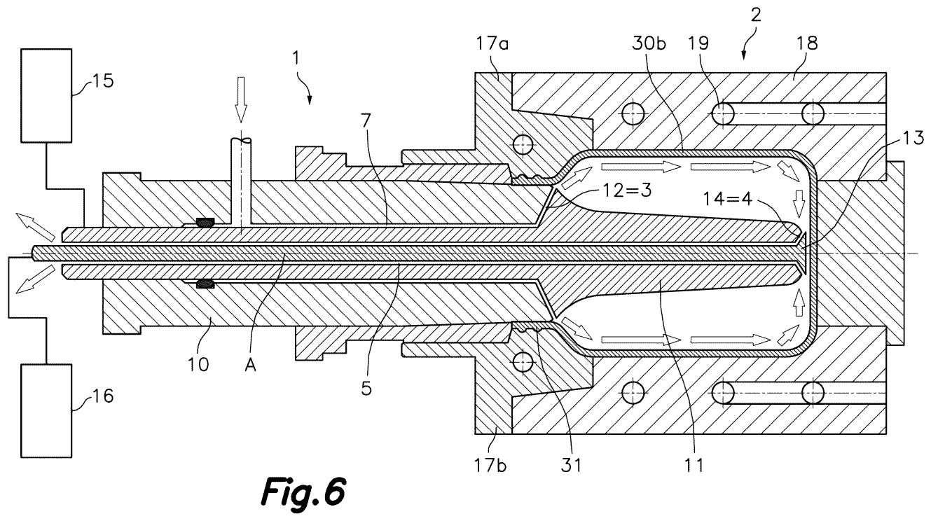

FIG. 6 shows an injection-blow-moulding mould according to a second example of the present invention which mainly differs from the first example described above with reference to FIGS. 1 and 2 in that the proximal gas passage 12 is connected to the first conduit 5 and thereby constitutes the first opening 3 and the distal gas passage 14 is connected to the second conduit 7 and thereby constitutes the second opening 4. The second example further differs from the first example in that a second actuator 16 (symbolically depicted in FIG. 6) is operatively connected to move the valve body 13 between the open position and the closed position instead of the elastic element.

The first opening 3 is formed all around the longitudinal axis A of the non-expandable punch 1 and is located at a proximal area of the non-expandable punch 1 defining a region of the preform 30a intended to form a shoulder of the container 30b and the second opening 4 is formed all around the longitudinal axis A of the non-expandable punch 1 and is located at a distal area of the non-expandable punch 1 defining a region of the preform 30a intended to form a bottom of the container 30b. So, in this second embodiment the cooling gas stream (indicated by arrows in FIG. 6) created inside the container 30b flows in an opposite direction to that of the first embodiment with an equivalent result.

Any one of the second and third variants of the blowing device shown in FIGS. 3A, 3B; 4A, 4B; and 5A, 5B may be applied to the second embodiment shown in FIG. 6.

In both the first and second examples of an injection-blow-moulding mould shown in FIGS. 1 and 2, and 6, the blow-moulding cavity 2 has a cylindrical inner surface intended to form a cylindrical body portion of the container 30b while the two neck half-moulds 17a, 17b are intended to form the neck and shoulder portions of the container 30b. This allows for the mould to open and the container 30b to be extracted from the blow-moulding cavity 2 in the axial direction. However, alternatively one pair of half blow-moulding cavities opening radially could be provided for forming containers having a more complex body shape without departing from the scope of the present invention.

The present invention also provides an injection-blow-moulding method comprising the following steps:
receiving a non-expandable punch inside a blow-moulding cavity with a preform arranged on the non-expandable punch in a hot and soft state, the non-expandable punch being non-expandable, being elongated in the axial direction and including at least one first opening and at least one second opening separated in the axial direction at opposite ends thereof, and the blow-moulding cavity defining an outer surface of a container to be obtained by blowing the preform;
delivering a pressurised gas to an interior of the preform simultaneously through at least one first opening and through at least one second opening during a blowing phase inflating the preform into the blow-moulding cavity until completely fills the blow-moulding cavity, the preform becoming the container;
delivering pressurised gas to an interior of the container only through either the at least one first opening or the at least one second opening during a cooling phase following the blowing phase, while releasing the pressurized gas from the interior of the container through either the at least one first opening or the at least one second opening not delivering pressurised gas to the interior of the container, creating a cooling stream of pressurised gas between the opposite ends of the non-expandable punch in direct contact with an inner surface of the container.

Thereby a gas stream is created, for example from the first opening 3 to the second opening 4 when the gas inside the container 30b exceeds the blowing pressure BP, and the gas stream cools an inner surface of the container 30b. Optionally, at the same time the outer surface of the container 30b in contact with the blow-moulding cavity 2 is cooled by a cooling device associated to the blow-moulding cavity 2.

The scope of the present invention is defined by the attached claims.

That which is claimed is:

1. An injection-blow-moulding mould comprising:
a non-expandable punch defining an inner surface of a preform, the non-expandable punch extending in an axial direction and including at least one first opening and at least one second opening separated in the axial direction at opposite ends thereof;
a blow-moulding cavity defining an outer surface of a container, the blow-moulding cavity being configured to receive therein the non-expandable punch with the preform arranged thereon in a hot and soft state;
a blowing device configured to deliver a pressurised gas to an interior of the preform simultaneously through the at least one first opening and through the at least one second opening during a blowing phase to inflate the preform into the blow-moulding cavity until completely fills the blow-moulding cavity, the preform becoming the container; and configured to deliver the pressurized gas to the interior of the preform only through either the at least one first opening or to the at least one second opening during a cooling phase following the blowing phase; and
a pressure-limiting device, connected to the at least one first opening or the at least one second opening which does not deliver pressurized gas of the blowing device during the cooling phase, and configured to release the pressurized gas from an interior of the container during the cooling phase creating a cooling stream of pressurised gas, between the opposite ends of the non-expandable punch, in direct contact with an inner surface of the container.

2. The injection-blow-moulding mould according to claim 1 wherein the blowing device is configured to deliver the pressurised gas at different pressures through the at least one first opening and through the at least one second opening.

3. The injection-blow-moulding mould according to claim 1 wherein the blowing device
is configured to deliver the pressurised gas into the preform during the blowing phase at a blowing pressure, suitable to blow the preform into the container, through the at least one first or second opening connected to the pressure-limiting device, and
is configured to deliver the pressurized gas into the preform during the blowing phase at an overpressure above the blowing pressure, through the at least one first or second opening not connected to the pressure-limiting device.

4. The injection-blow-moulding mould according to claim 3 wherein the blowing device comprises:
a first blowing device including a first source of pressurized gas configured to provide pressurized gas at the overpressure above the blowing pressure; and
a second blowing device including a second source of pressurized gas configured to provide pressurized gas at the blowing pressure.

5. The injection-blow-moulding mould according to claim 1, wherein the pressure-limiting device is connected to the at least one second opening located at a proximal end of the non-expandable punch, creating a cooling gas stream into the container from a distal end of the non-expandable punch towards a proximal end thereof.

6. The injection-blow-moulding mould according to claim 1, wherein the pressure-limiting device is connected to the at least one first opening located at a distal end of the non-expandable punch, creating a cooling gas stream into the container from a proximal end of the non-expandable punch towards a distal end thereof.

7. The injection-blow-moulding mould according to claim 1, wherein the pressure-limiting device comprises a pressure-limiting valve set to open when the pressure in the interior of the container is above the blowing pressure, releasing pressurized gas from the interior of the container.

8. The injection-blow-moulding mould according to claim 1 wherein the injection-blow-moulding mould further comprises a cooling device configured to cool an inner surface of the blow-moulding cavity and the outer surface of the container in contact therewith.

9. The injection-blow-moulding mould according to claim 1, further comprising an opening and closing device configured to open and close the at least one first opening and the at least one second opening when the blow opening carrying the preform is located inside the blow-moulding cavity.

10. The injection-blow-moulding mould according to claim 9, wherein the non-expandable punch comprises a base body and a forming body, the forming body being movable with respect to the base body in an axial direction that is coaxial to a longitudinal axis of the non-expandable punch between an open position, in which a gap between the base body and the forming body provides a proximal gas passage, and a closed position, in which there is no gap or gas passage between the base body and the forming body.

11. The injection-blow-moulding mould according to claim 10, wherein the non-expandable punch further comprises a valve body that is movable with respect to the forming body in the axial direction between an open position, in which a gap between the forming body and the valve body provides a distal gas passage, and a closed position, in which there is no gap or gas passage between the forming body and the valve body.

12. The injection-blow-moulding mould according to claim 11, wherein the proximal gas passage constitutes the at least one second opening, and the distal gas passage constitutes the at least one first opening.

13. The injection-blow-moulding mould according to claim 11, wherein the proximal gas passage constitutes the at least one first opening, and the distal gas passage constitutes the at least one second opening.

14. An injection-blow-moulding method comprising:
receiving a non-expandable punch inside a blow-moulding cavity with a preform arranged on the non-expandable punch in a hot and soft state, the non-expandable punch being non-expandable, being elongated in the axial direction and including at least one first opening and at least one second opening separated in the axial direction at opposite ends thereof, and the blow-moulding cavity defining an outer surface of a container to be obtained by blowing the preform;
delivering a pressurised gas to an interior of the preform simultaneously through at least one first opening and through at least one second opening during a blowing phase inflating the preform into the blow-moulding cavity until completely fills the blow-moulding cavity, the preform becoming the container; and
delivering pressurised gas to an interior of the container only through either the at least one first opening or the at least one second opening during a cooling phase following the blowing phase, while releasing the pressurized gas from the interior of the container through either the at least one first opening or the at least one second opening not delivering pressurised gas to the interior of the container, creating a cooling stream of pressurised gas between the opposite ends of the non-expandable punch in direct contact with an inner surface of the container.

15. The injection-blow-moulding method according to claim 14 wherein the pressurised gas is delivered at different pressures through the at least one first opening and through the at least one second opening.

16. The injection-blow-moulding method according to claim 14 wherein
the pressurised gas is delivered into the preform during the blowing phase at a blowing pressure, suitable to blow the preform into the container, through the at least one first or second opening connected to the pressure-limiting device, and
the pressurized gas is delivered into the preform during the blowing phase at an overpressure above the blowing pressure, through the at least one first or second opening not connected to the pressure-limiting device.

17. The injection-blow-moulding method according to claim 14 wherein the pressurised gas is released from the interior of the container through the at least one second opening, which is located at a proximal end of the non-expandable punch, creating a cooling gas stream into the container from a distal end of the non-expandable punch towards a proximal end thereof.

18. The injection-blow-moulding method according to claim 14, wherein the pressurised gas is released from the interior of the container through the at least one first opening located, which is located at a distal end of the non-expandable punch, creating a cooling gas stream into the container from a proximal end of the non-expandable punch towards a distal end thereof.

19. The injection-blow-moulding method according to claim 14, wherein the release of the pressurised gas during the cooling phase is produced by opening a pressure-limiting valve set to open when the pressure in the interior of the container is above the blowing pressure.
